(19) United States
(12) Patent Application Publication
(10) Pub. No.: US 2019/0098527 A1
(43) Pub. Date: Mar. 28, 2019

(54) PSEUDORANDOM SCHEDULING METHOD AND APPARATUS IN WIRELESS NETWORKS

(71) Applicants: Derek HILBORN, Bothell, WA (US); Nokia Solutions and Networks OY, Espoo (FI)

(72) Inventors: Derek HILBORN, Bothell, WA (US); David J. RYAN, Jackson, WY (US)

(21) Appl. No.: 16/087,612

(22) PCT Filed: Aug. 5, 2016
(86) PCT No.: PCT/US16/45886

§ 371 Date: Sep. 21, 2018

Related U.S. Application Data
(63) Continuation of application No. 15/078,927, filed on Mar. 23, 2016, now abandoned.
(60) Provisional application No. 62/136,947, filed on Mar. 23, 2015.
(60) Provisional application No. 62/137,025, filed on Mar. 23, 2015.
(60) Provisional application No. 62/136,994, filed on Mar. 23, 2015.
(60) Provisional application No. 62/137,031, filed on Mar. 23, 2015.
(60) Provisional application No. 62/136,894, filed on Mar. 23, 2015.
(60) Provisional application No. 62/136,967, filed on Mar. 23, 2015.

(51) Int. Cl. H04W 28/02; H04W 24/02; H04W 16/18

(52) U.S. Cl. CPC H04W 28/021; H04W 24/02; H04W 16/18; Y02D 70/00; Y02D 70/1224; Y02D 70/1264; Y02D 70/146; Y02D 70/1242; Y02D 70/1262; Y02D 70/142

(57) ABSTRACT

Random distributions of elements in a power schedule can be used to reduce interference in wireless communication networks with multiple transmitters. A random power schedule may be implemented by determining a first random power schedule for a first base station, wherein the first random power schedule is an orthogonal frequency division multiplexing (OFDM) schedule that associates a random distribution of a plurality of power levels with a corresponding plurality of time and frequency resources, assigning transmissions from the first base station to a plurality of mobile devices to the plurality of time and frequency resources, and transmitting data to the plurality of mobile devices at the respective plurality of power levels.

### CROSS-REFERENCES TO RELATED APPLICATIONS

The present disclosure claims priority to U.S. application Ser. No. 15/078,927 filed Mar. 23, 2016, which claims priority from U.S. Provisional Application No. 62/137,025, filed Mar. 23, 2015, and U.S. Provisional Application No. 62/136,947, filed Mar. 23, 2015, U.S. Provisional Application No. 62/136,994, filed Mar. 23, 2015, U.S. Provisional Application No. 62/137,031, filed Mar. 23, 2015, U.S. Provisional Application No. 62/136,894, filed Mar. 23, 2015, U.S. Provisional Application No. 62/136,967, filed Mar. 23, 2015, each of which are incorporated by reference herein for all purposes.

### BACKGROUND

Wireless access networks utilize a fixed set of time and frequency channels to carry user data to individual network subscribers. Due to commercial demands on network data throughput coupled with costly and limited radio frequency spectrum, system operators reuse channel resources at as many wireless base stations or cells as possible. The universal reuse approach allows base stations to use all licensed channels and offers the potential for very high network data throughput, but also creates the potential for high levels of interference in heavily loaded systems as nearby base stations simultaneously allocate the same channels. In addition to raising interference levels that result in data being carried in less efficient modulation modes, channel reuse also leads to poor coverage reliability to cell edge users located far from their serving base station.

Various schemes such as fractional frequency reuse have been defined for broadband orthogonal frequency division multiplexing (OFDM) systems, in which a portion of the available channels are allocated universally to all cells, and portions of the overall channel pool are restricted such that near neighbor cells do not simultaneously utilize these channels. This approach is effectively a compromise between traditional static reuse planning and universal frequency reuse, and is effectively a compromise between these two technologies in terms of data throughput and coverage reliability.

The overall efficiency of fractional reuse in terms of network data throughput and spectrum utilization is limited by pre-provisioned fractional channel blocks that assume steady loading levels between neighboring cells. In essence, a portion of the overall channel pool is set aside and not utilized at each cell to assure coverage reliability to cell edge users regardless of actual loading patterns or propagation environments.

Various interference limiting approaches have been offered that leverage the transmitted power and or phase characteristics at each cell to reduce interference levels between adjacent cells utilizing the same channels. These soft-fractional frequency reuse schemes can be generally categorized into two groups: 1. those that pre provision static channel sub blocks for reuse across neighboring cells; and 2. those that utilize closed loop feedback systems to automatically optimize channel distribution in frequency, time, power or phase such that interference is reduced in accordance with dynamic system loading and RF propagation.

These latter approaches offer the highest overall network performance in terms of both data throughput and coverage reliability, but require additional network processes or components to carry out the closed loop optimization tasks. In both cases the goal is to increase the probability of allocating channels to users with acceptably low levels of interference such that coverage is adequate across the operating region and data can be reliably transferred using high data rate modulation and coding schemes.

### FIELD OF TECHNOLOGY

Embodiments of the present disclosure are directed to wireless communications, and to implementing locally random elements in a wireless transmission schedule.

### BRIEF SUMMARY

In an embodiment, a method for a wireless communication network includes determining a first random power schedule for a first base station, wherein the first random power schedule is an orthogonal frequency division multiplexing (OFDM) schedule that associates a random distribution of a plurality of power levels with a corresponding plurality of time and frequency resources, assigning the plurality of time and frequency resources to a plurality of mobile devices, and transmitting data from the first base station to the plurality of mobile devices at the respective plurality of power levels.

Determining the first random power schedule may include generating a sequence of values using a pseudorandom number generator located at the first base station. The pseudorandom number generator may be seeded with a seed value associated with the first base station, where the seed value is known to a plurality of neighboring base stations that neighbor the first base station.

In an embodiment, a binary sequence output from the pseudorandom number generator is converted into a set of integers, each integer of the set of integers corresponding to each power level of the plurality of power levels, and a resulting sequence of power levels is applied to the random power schedule.

In another embodiment, the first base station determines random power schedules of neighboring base stations by inputting respective seed values for the neighboring base stations into the pseudorandom number generator and advancing the output sequences according to a frame count. Determining the first random power schedule may include selecting the first random power schedule from a predetermined set of power schedules.

In an embodiment, the method may further include determining a plurality of random power schedules for a plurality of base stations in the wireless communications network from the predetermined set of power schedules based on a reuse scheme. The first random power schedule may be compared to power schedules of neighboring base stations, wherein the transmissions are assigned to the plurality of mobile devices based on a result of the comparison.

The first random power schedule may be replaced with a second random power schedule at a predetermined time interval. In such an embodiment, the first base station may determine respective random power schedules of neighboring base stations using a number of the predetermined time intervals that have elapsed since an origin time.

### BRIEF DESCRIPTION OF THE DRAWINGS

FIG. 1 illustrates a wireless communications system according to an embodiment.

FIG. 2 illustrates a network resource controller according to an embodiment.

FIG. 3 illustrates a process for wireless communications using random power schedules in a wireless communications network according to an embodiment.

FIG. 4A illustrates a random power schedule according to an embodiment.

FIG. 4B illustrates a random power schedule with grouped resources according to an embodiment.

FIG. 5 illustrates a process for local random power schedules according to an embodiment.

FIG. 6 illustrates a schematic of a scheduler and pseudorandom number generator according to an embodiment.

FIG. 7 illustrates a pseudorandom nu giber generator according to an embodiment.

FIG. 8A illustrates an output from a pseudorandom number generator according to an embodiment.

FIG. 8B illustrates an output from a pseudorandom number generator according to an embodiment.

FIG. 9 illustrates a process of using a pseudorandom number generator to create a random power schedule according to an embodiment.

FIG. 10 illustrates wireless transmissions and interference between neighboring coverage areas according to an embodiment.

FIG. 11 illustrates a process for predetermined random power schedules according to an embodiment.

FIG. 12 illustrates a reuse scheme according to an embodiment.

### DETAILED DESCRIPTION OF THE INVENTION

A detailed description of embodiments is provided below along with accompanying figures. The scope of this disclosure is limited only by the claims and encompasses numerous alternatives, modifications and equivalents. Although steps of various processes are presented in a particular order, embodiments are not necessarily limited to being performed in the listed order. In some embodiments, certain operations may be performed simultaneously, in an order other than the described order, or not performed at all.

Numerous specific details are set forth in the following description in order to provide a thorough understanding. These details are provided for the purpose of example and embodiments may be practiced according to the claims without some or all of these specific details. For the purpose of clarity, technical material that is known in the technical fields related to this disclosure has not been described in detail so that the disclosure is not unnecessarily obscured.

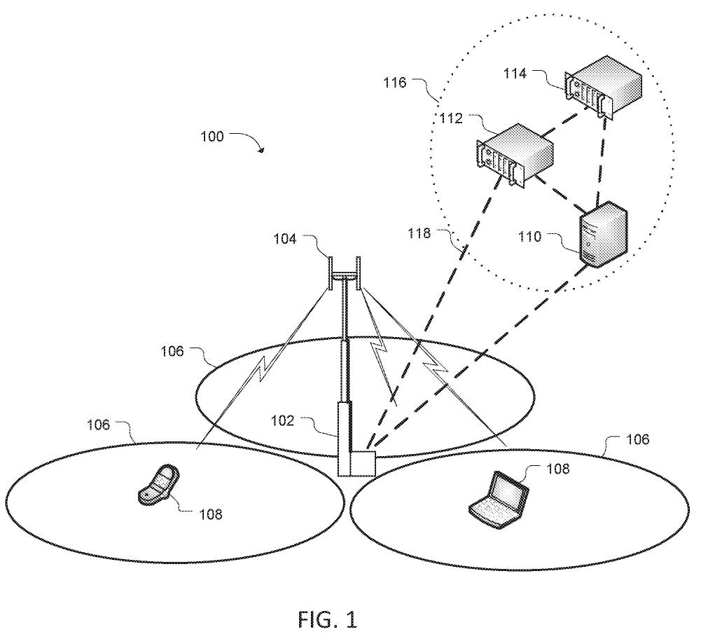

FIG. 1 illustrates a networked communications system 100 according to an embodiment of this disclosure. System 100 may include one or more base stations 102, each of which are equipped with one or more antennas 104. Each of the antennas 104 may provide wireless communication for user equipment (UE) 108 in one or more cells 106. Base stations 102 have antennas 104 that are receive antennas which may be referred to as receivers, and transmit antennas, which may be referred to as transmitters. As used herein, the term “base station” refers to a wireless communications station provided in a location and serves as a hub of a wireless network. For example, in LTE, a base station may be an eNodeB. The base stations may provide service for macrocells, microcells, picocells, or femtocells. In other embodiments, the base station may be an access point in a Wi-Fi network.

The one or more UE 108 may include cell phone devices, laptop computers, handheld gaming units, electronic book devices and tablet PCs, and any other type of common portable wireless computing device that may be provided with wireless communications service by a base station 102. In an embodiment, any of the UE 108 may be associated with any combination of common mobile computing devices (e.g., laptop computers, tablet computers, cellular phones, handheld gaming units, electronic book devices, personal music players, video recorders, etc.), having wireless communications capabilities employing any common wireless data communications technology, including, but not limited to: GSM, UMTS, 3GPP LTE, LTE Advanced, WiMAX, etc.

The system 100 may include a backhaul portion 116 that can facilitate distributed network communications between backhaul equipment or network controller devices 110, 112 and 114 and the one or more base station 102. As would be understood by those skilled in the art, in most digital communications networks, the backhaul portion of the network may include intermediate links 118 between a backbone of the network which are generally wire line, and sub networks or base stations located at the periphery of the network. For example, cellular mobile devices (e.g., UE 108) communicating with one or more base station 102 may constitute a local sub network. The network connection between any of the base stations 102 and the rest of the world may initiate with a link to the backhaul portion of a provider's communications network (e.g., via a point of presence).

In an embodiment, the backhaul portion 116 of the system 100 of FIG. 1 may employ any of the following common communications technologies: optical fiber, coaxial cable, twisted pair cable, Ethernet cable, and power-line cable, along with any other wireless communication technology known in the art. In context with various embodiments, it should be understood that wireless communications coverage associated with various data communication technologies (e.g., base station 102) typically vary between different service provider networks based on the type of network and the system infrastructure deployed within a particular region of a network (e.g., differences between GSM, UMTS, LTE, LTE Advanced, and WiMAX based networks and the technologies deployed in each network type).

Any of the network controller devices 110, 112 and 114 may be a dedicated Network Resource Controller (NRC) that is provided remotely from the base stations or provided at the base station. Any of the network controller devices 110, 112 and 114 may be a non-dedicated device that provides NRC functionality. In another embodiment, an NRC is a Self-Organizing Network (SON) server. In an embodiment, any of the network controller devices 110, 112 and 114 and/or one or more base stations 102 may function independently or collaboratively to implement processes associated with various embodiments of the present disclosure.

In accordance with a standard GSM network, any of the network controller devices 110, 112 and 114 (which may be NRC devices or other devices optionally having NRC functionality) may be associated with a base station controller (BSC), a mobile switching center (MSC), a data scheduler, or any other common service provider control device known in the art, such as a radio resource manager (RRM). In accordance with a standard UMTS network, any of the network controller devices 110, 112 and 114 (optionally having NRC functionality) may be associated with a NRC, a serving GPRS support node (SGSN), or any other common network controller device known in the art, such as an RRM. In accordance with a standard LTE network, any of the network controller devices 110, 112 and 114 (optionally having NRC functionality) may be associated with an eNodeB base station, a mobility management entity (MME), or any other common network controller device known in the art, such as an RRM.

In an embodiment, any of the network controller devices 110, 112 and 114, the base stations 102, as well as any of the UE 108 may be configured to run any well-known operating system. Any of the network controller devices 110, 112 and 114 or any of the base stations 102 may employ any number of common server, desktop, laptop, and personal computing devices.

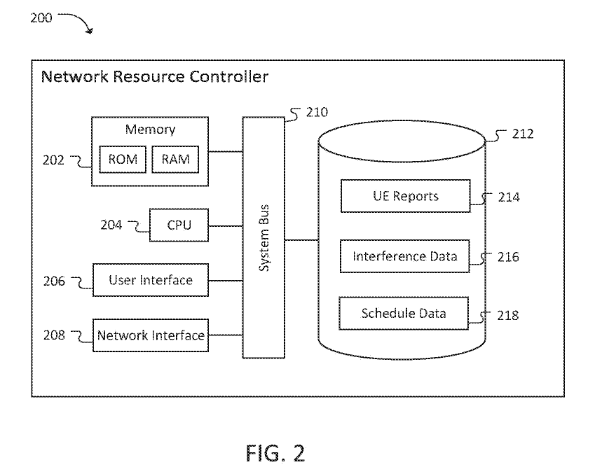

FIG. 2 illustrates a block diagram of an NRC 200 that may be representative of any of the network controller devices 110, 112 and 114. Accordingly, NRC 200 may be representative of a Network Management Server (NMS), an Element Management Server (EMS), a Mobility Management Entity (MME), a SON server, etc. The NRC 200 has one or more processor devices including a CPU 204.

The CPU 204 is responsible for executing computer programs stored on volatile (RAM) and nonvolatile (ROM) memories 202 and a storage device 212 (e.g., HDD or SSD). In some embodiments, storage device 212 may store program instructions as logic hardware such as an ASIC or FPGA. Storage device 212 may store, for example, UE reports 214, interference data 216, and schedule data 218.

The NRC 200 may also include a user interface 206 that allows an administrator to interact with the NRC's software and hardware resources and to display the performance and operation of the system 100. In addition, the NRC 200 may include a network interface 208 for communicating with other components in the networked computer system, and a system bus 210 that facilitates data communications between the hardware resources of the NRC 200.

In addition to the network controller devices 110, 112 and 114, the NRC 200 may be used to implement other types of computer devices, such as an antenna controller, an RF planning engine, a core network element, a database system, or the like. Based on the functionality provided by an NRC, the storage device of such a computer serves as a repository for software and database thereto.

Embodiments of the present disclosure include a system and process that use random power schedules in a wireless communications environment. Although specific embodiments are described with respect to a cellular LTE system, the scope of this disclosure extends to other wireless transmission technologies that have a plurality of transmission power levels. Embodiments are suitable for various OFDM-based wireless technologies, including the IEEE 802.11 set of standards.

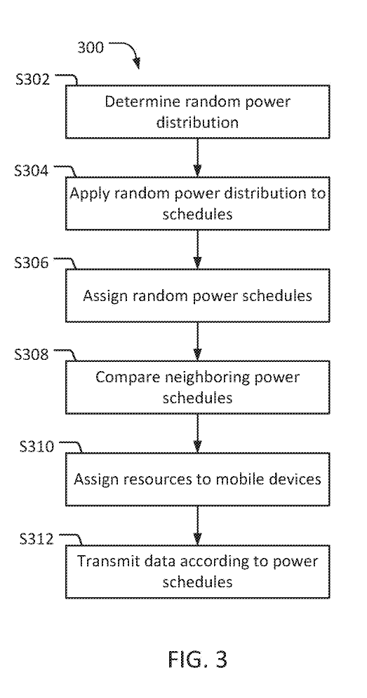

FIG. 3 illustrates an embodiment of a process 300 for wireless communications using random power schedules in a wireless communications network.

Random power schedules are determined at S302. A randomized power schedule has more than one transmit power value to apply to a particular wireless transmission. At the most basic level, a schedule can have two power levels, such as high and low.

In an LTE system, power levels are highly adaptable. The power levels are typically expressed in terms of a backoff level from full power, where 0 dB is no backoff, or transmit at full power, −3 dB is a backoff of three decibels from full power, −6 dB is a backoff of six decibels from full power, etc. Experimentation has demonstrated that four power levels results in substantial interference reduction, while additional power levels beyond four have less effect on interference.

A random power distribution may be generated in various ways. Random and pseudorandom number generators are well known, and conventional random or pseudorandom number generators may be employed to generate a sequence of randomly distributed values. Pseudorandom number generators typically have patterns that repeat at some point in a sequence. However, when the repetition interval is large, a smaller set of the pseudorandom sequence will appear to be statistically random. Thus, an embodiment may use a pseudorandom number (PN) generator to create a locally random sequence of values.

Determining a random power distribution may include translating the locally random values from a PN generator into power levels. Computationally-based PN generators are typically based on binary sequences, so these binary sequences can be converted to N number of power levels using known techniques, such as summing consecutive bits, in order to convert the binary values into power levels.

The random distribution of power levels from S302 is applied to a wireless transmission schedule at S304. The random numbers may be applied by correlating the random power levels with time and frequency resources in a transmission schedule. In one embodiment, the random power values are sequentially applied to each channel or sub-channel in the frequency domain for a particular time period.

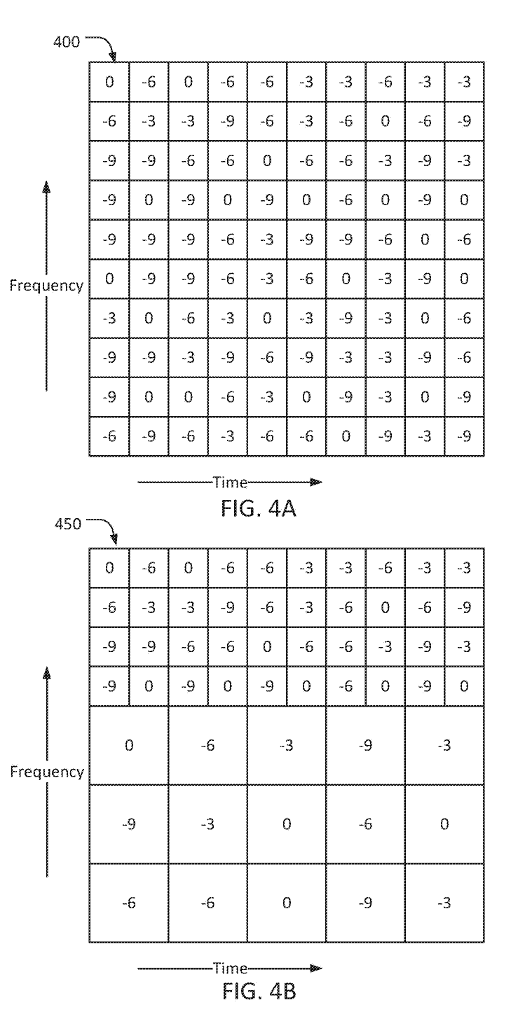

FIG. 4A shows an example of a power schedule 400 with random power levels. The power schedule 400 is divided into ten sub-channels in the frequency domain and ten time slots in the time domain. The power levels in the schedule represent four different power backoff levels: 0 dB, −3 dB, −6 dB and −9 dB.

Although schedule 400 shows evenly distributed time and frequency resources, transmission schedules in some technologies selectively combine time and frequency resources to efficiently transmit data. For example, in LTE, a basic unit of time and frequency resources is a Physical Resource Block (PRB). A single PRB has a time dimension of 0.5 ms, and a frequency dimension of 180 kHz, which comprise 12 sub-carriers spaced apart by 15 kHz. One Transmission Time Interval (TTI) equals 2 PRBs in the time domain and spans 1 ms. Other technologies may refer to time units as time slots, frames, etc.

However, when scheduling downlink transmissions to mobile equipment, a scheduler may combine a plurality of PRBs in both time and frequency dimensions into a Resource Block Group (RBG). Therefore, in an embodiment, random power levels are applied to groups of adjacent time and frequency resources. Such a schedule is illustrated by FIG. 4B, which shows a transmission schedule similar to schedule 400, except that the lower frequencies are allocated according to groups of time and frequency resources.

The random power schedules are assigned to transmitters that will transmit data at the power levels indicated in the schedules at S306. Each power schedule may be assigned to a transmitter that transmits data to a particular coverage area. For example, a power schedule may he assigned to each cell of a cellular base station that serves a plurality of cells.

Optimum interference reductions are realized when the power schedules of adjacent base stations are different from one another. Therefore, when a limited number of predetermined random power schedules are allocated to various base stations through a central controller, they may be allocated in such a way that no two adjacent coverage areas are using the same power schedule. For example, the random power schedules may be assigned according to a reuse scheme. A distinction is made here between schedules with power attributes (power schedules) and the scheduling of packet data transmissions by a base station which results in a packet data schedule.

In some embodiments, random power schedules are generated at each base station. In such embodiments, each random power schedule is inherently different from the power schedules of adjacent transmitters.

In order to minimize interference to mobile devices, it can be helpful to know the power schedules of nearby transmitters. Accordingly, power schedules may be compared to one another at S308.

Comparing power schedules at S308 may include determining which power levels of a first base station are aligned with power levels of neighboring base stations. For example, comparing power schedules at S308 may include determining that certain resources to which a high power level is assigned at a first base station are aligned with lower power levels in power schedules of neighboring transmitters. The serving base station can use such information to optimize spectral efficiency, for example, by assigning higher power transmissions to improve communications with mobile devices experiencing higher levels of interference. In some embodiments, the schedule information of neighboring base stations can be combined with other information, such as distance or signal levels, to improve the accuracy of interference estimates used to determine a schedule.

Time and frequency resources associated with random power levels are allocated to downlink transmissions from base stations to mobile equipment at S310. The resources may be assigned according to characteristics of each mobile device, so that higher power resources are assigned to mobile devices that benefit the most from those resources. For example, higher power level resources may be assigned to transmissions to mobile devices at edges of a coverage area associated with a base station, while lower power resources are assigned to mobile devices that are in the middle of the coverage area.

Resources may be assigned according to metrics collected by the mobile devices that are available to a scheduling entity. For example, resources may be assigned at S310 according to Channel Quality Indicator (CQI) and. Carrier to Interference plus Noise (CINR) metrics for the mobile devices. Other criteria, such as Quality of Service (QoS) requirement, may be taken into account when assigning resources to mobile devices. Data is transmitted according to the power levels of the random power schedule at S312.

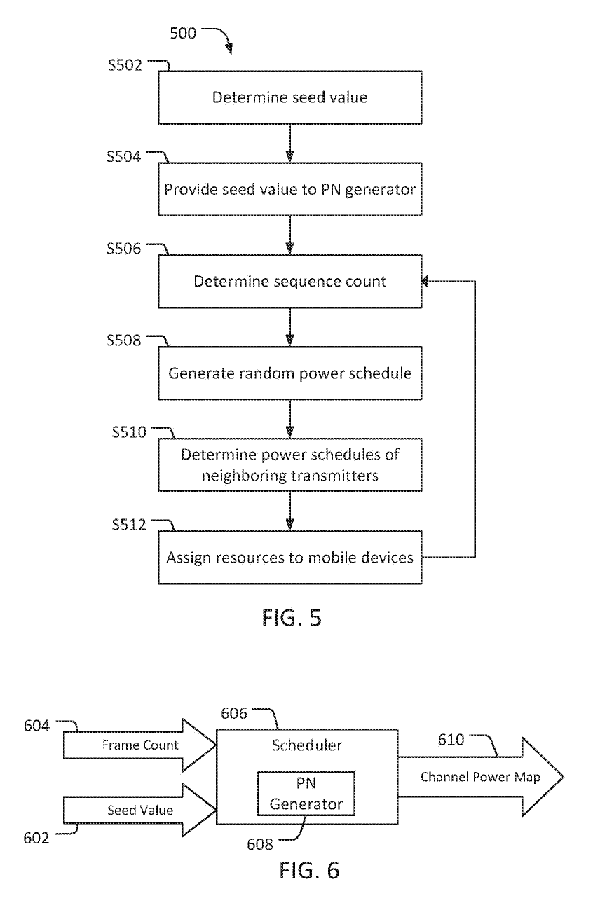

FIG. 5 illustrates an embodiment of a process 500 for local random power schedules. Embodiments of process 500 may be performed by local wireless communication schedulers, such as the schedulers located in base stations. FIG. 6 shows an embodiment of inputs and outputs of a scheduler 606 that may be used to generate a random power schedule according to an embodiment of process 500.

A seed value 602 for a power schedule is determined at S502. In an embodiment, the seed value 602 is a unique value associated with the particular transmitter, such as a global identifier or serial number for a given transmitter, such as a Cell Global identity (CGI) in an LTE system. In other embodiments, the identifier may be a Base Station Identity Code (BSIC), or a modification of a BSIC for a particular transmitter, or cell, of a base station. In some embodiments, the seed value 602 may be a non-unique identifier that is used to identify the base station in a particular network or network area.

In an embodiment, the seed value 602 for a particular base station is not used by any neighboring base stations. Put another way, a seed value for a first transmitter may be the only instance of that seed value used by transmitters whose transmissions substantially interfere with the first transmitter.

In an embodiment, the seed value 602 determined at S502 is based on a value that is known to neighboring base stations. When the seed value is known to neighbors, a scheduler Can use that seed value to determine the power levels of neighboring transmissions.

When seed values for neighboring transmitters begin with long strings of zeroes, then the degree of randomness between different schedules may be diminished. Accordingly, determining seed values at S502 may include performing a hash function or some other process to decrease the amount of order between seed values.

When the seed value is determined at S502, it is provided to PN generator 608 that generates a sequence of pseudorandom numbers at S504.

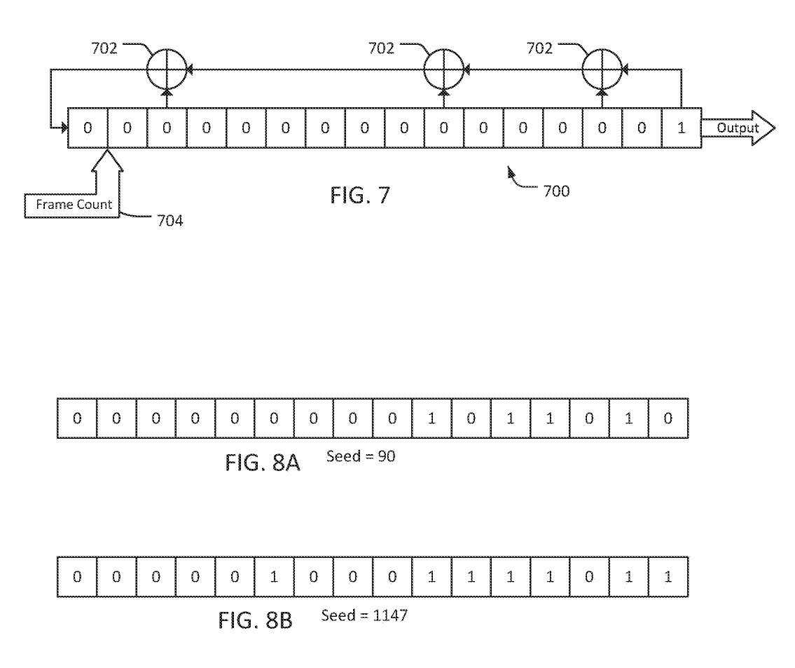

The PN generator 608 shown in FIG. 6 represents a deterministic function that may be common to all wireless base stations that generates a known, repeatable pseudorandom number sequence. One embodiment of a PN generator is the linear feedback shift register 700 with three taps 702 shown in FIG. 7.

The PN Generator 700 of FIG. 7 is provided with an associated transmitter's seed value to initiate PN generation. With each successive increment of the frame count clock 704, the bits within the register are shifted to the right while the rightmost bit (shown as ‘1’ in FIG. 7) is shifted to the output. Each of the bits tapped by taps 702 is summed via modulo two arithmetic, which may be implemented as a logical XOR operation, and the bit representing the logical sum of these operations is fed back to the left most position of the shift register. By appropriate choice of feedback taps 702 and overall register length a pseudorandom output sequence of binary bits is produced through successive shifting of register bits in response to the Shift clock 704 FIG. 7.

The bit sequence output by linear feedback shift register 700 will repeat every 2 L-1 clock cycles, where L represents the shift register length. The 16 bit register shown in FIG. 7 will produce a sequence of 65535 output bits before repeating the same sequence.

Embodiments of PN generator 700 may have one or more of the following properties.

First, the output sequence may have approximately the same number of output ones and zeros. Furthermore, when translated into power levels, the distribution of values will be about the same. For example, a binary output sequence may have a mean value near to 0.5, where about half the values are 0 and about half the values are 1.

Second, the sequence output by the PN generator 700 may have approximately equal occurrence of bit ‘runs’ of arbitrary length. In other words, the number of consecutive bits of the same magnitude will occur with roughly equal frequency throughout the distribution so that the occurrence of consecutive sequences of zeros or consecutive ones will be approximately random. An embodiment may have lower numbers of runs of the same value, e.g. 000000000000 and 111111111111.

Third, the sequence may appear random and ‘noise like’ across an arbitrary sample of its overall length. This implies that suitable sub-sections of the sequence will be statistically decorrelated to one another such that, for example, a selection of 100 output bits taken from randomly chosen different points in the overall sequence do not strongly correlate to one another.

Fourth, all combinations of ones and zeros possible within the defined shift register length, which is 16 for PN generator 700 shown in FIG. 7, may be represented at points within the overall sequence, with the exception of the null case of all zeros.

Fifth, the specific PN generator function and seed may be chosen such that each sequential code yielded by subsequent shifts of the PN sequence result in unique codes with low cross correlation to other codes in the sequence. For instance, seeding some generators with an all zero seed value may result in all subsequent output values carrying the same all zero value, so such combinations of seed values and generators are avoided.

When a PN generator 700 has these properties, especially the fourth property where all possible combinations of ‘L’ bits, apart from the null case of all zeros, is present at some point in the overall sequence, it is possible to seed the PN generator with an arbitrary sequence of ‘L’ bits and generate a predictable and repeatable sequence of pseudorandom numbers. Accordingly, any given combination of bits in the register can be arrived at by inputting a non-null seed and clocking the sequence forward by a particular number of clock cycles.

In other words, seeding a well-designed sequence with an arbitrary sequence of ‘L’ bits simply shifts the output to a fixed offset relative to the cyclic start of the default sequence shown in FIG. 7. This property allows the same PN generator 700 to be seeded with transmitter-specific information such that it continues to produce the same overall output sequence with a fixed offset.

Embodiments of the pseudorandom number generator 700 are not limited to a linear feedback shift register. In other embodiments, the pseudorandom number generator may be a linear congruential generator, Mersenne Twister, etc.

FIG. 8A and FIG. 8B illustrate binary representations for two integer seed values extended to 16 bits in length. FIG. 8A shows the binary sequence for the integer 90 seeded into the same PN generator 700 as shown in FIG. 7. Subsequent cycles of a frame count register clock will continue to produce random values.

Similarly, seeding the sequence with a binary representation of seed value 1147 as shown in FIG. 8B effectively results in a different offset into an overall cyclical PN sequence. The pseudorandom nature of subsets of the overall sequence results in low correlation between these two shifted sequences.

A count value, or frame count, is determined at S506. The count value may be determined based on an origin time, which is a time point at which a first schedule in a series of schedules is determined. While the first power schedule in a sequence of power schedules may be generated by inputting a seed value into a PN generator and sequentially setting outputs from the generator as power levels, the random power schedule for a particular transmitter may he replaced at predetermined intervals.

The same seed value and PN generator can be used to generate subsequent random power schedules for a transmitter by running the PN generator at predetermined points in the sequence of outputs. Accordingly, subsequent random power schedules may be determined by advancing through the sequence of outputs from a PN generator by a predetermined offset value from the first output based on the seed value.

The offset may be tied to known system wide timing information, such as frame or sub-frame indexing information. In a specific embodiment, counts are indexed to a superframe interval. In other embodiments, a time used to index the PN generator may be a globally known time value, such as a time value synchronized to GPS satellites or NIST time.

For example, an embodiment in an LTE system may generate a power schedule by assigning power levels according to the first series of values output from a PN generator. This schedule is used by a transmitter for a superframe clock cycle of 20 ms. Meanwhile, a second power schedule is generated from a sequence of outputs from the PN generator that is offset from the seed value by a predetermined number of cycles. In other words, the second power schedule is generated in the same manner as the first power schedule, except that while the first value in the first power schedule is based on the first output from the initial seed value, the first value in the second power schedule is based on the first output from the PN generator that is a predetermined number of cycles after the seed value.

A random power schedule is generated from the sequence generated by the PN generator 700 at S508. Translating subsets of the PN generator output sequence to power levels in a random power schedule can be accomplished by collecting a suitable portion of output sequence bits and grouping the bits appropriately to support the desired power levels.

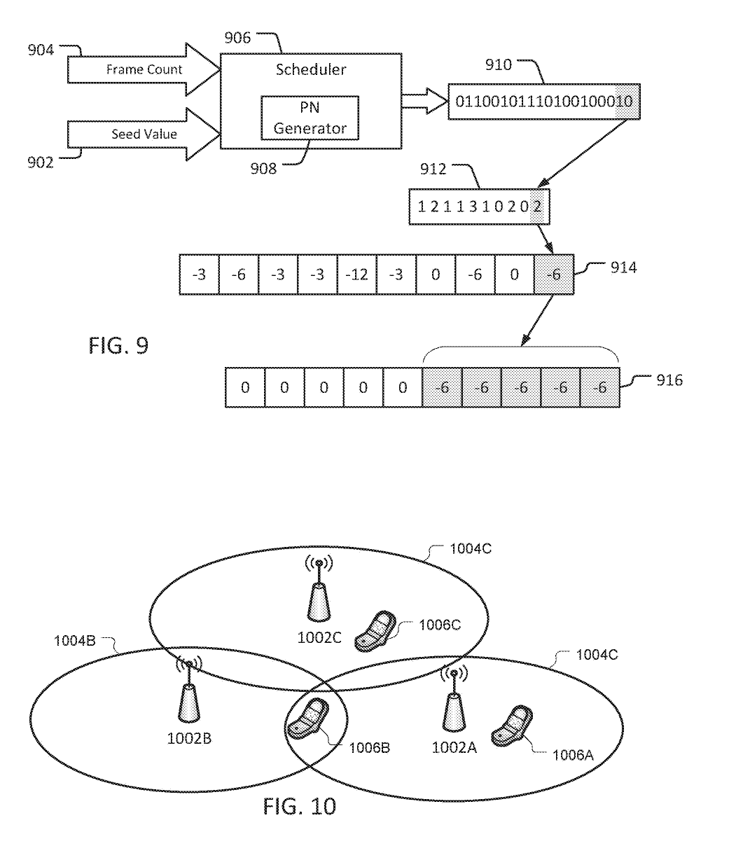

For example, as seen in FIG. 9, a system supporting four transmit power levels of 0 dB, −3 dB, −6 dB, −12 dB relative to full power operation may group PN generator output bits 910 into dibit pairs. Each dibit pair represents a value from zero to four which is mapped to the four defined power levels seen in sequence 912. Similarly, a system supporting eight defined transmit power levels can collect groups of three PN generator output bits to represent each level.

A system supporting integer non-power-of-two power levels (e.g., five defined levels) may collect groups of three PN generator outbits and skip/ignore any groups that do not map to a defined power level. The Overall section of output sequence collected to create the power output map can be provisioned based on the number of physical layer channel resources available to the system and the desire to group blocks of resources.

For example, a typical 10 MHz LTE system supports 50 PRBs in a 10 MHz channel within a single TTI. Assuming a desire to group these into 10 power blocks each containing 5 PRBs and a system supporting four transmit power levels the processing may be grouped as shown in sequence 916 of FIG. 9,

FIG. 9 shows a process of using a PN generator to create a random power schedule. More specifically, FIG. 9 illustrates using system frame count timing 904 along with a seed value 902 to generate an offset into a globally known PN sequence, and using a section of the output sequence 910 to determine appropriate transmit power weighting for LTE sub channels. The process used to assign transmit power weighting to a given base station's resources based on system clock and a known seed value 902 also allows base stations to know what power weightings nearby base stations will utilize for each resource on subsequent transmissions based only on the globally known system clock and the seed values associated with each neighboring transmitter.

Power schedules of neighboring transmitters are determined at S510. In an embodiment, the same global PN generating function and the absolute frame count are known to all base stations within the system based on system time synchronization boundaries. By seeding the sequence with base station specific data that fills the PN generator shift register, each base station in a wireless system can locally generate its own sequence with appropriate offset as well as the sequence of other nearby base stations simply by providing their known seed values into the common PN generator.

Resources are assigned to mobile devices at S512. The resources may be assigned logically in order to limit unnecessary interference from neighboring transmitters. In some embodiments, after a predetermined period of time has passed, a new random power schedule is determined by returning to S506 of process 500.

FIG. 10 shows an embodiment of assigning power levels to mobile devices 1006 in a wireless communication system. In the embodiment of FIG. 10, three base stations 1002A, 1002B and 1002C provide wireless service to mobile devices 1006A, 1006B and 1006C in coverage areas 1004A, 1004B and 1004C, respectively. Mobile device 1006B is at an edge of coverage area 1004B that overlaps with coverage area 1004C. Meanwhile, mobile device 1006C is close to coverage areas 1004B and 1004C, so it receives a moderate amount of interference from base stations 1002A and 1002B, but less interference than mobile device 1006B. Mobile device 1006A is farther from neighboring coverage areas, so it receives less interference than mobile devices 1006B and 1006C.

Assuming that three different power levels are available for the same resources in the system of FIG. 10, an optimum assignment at S512 would be for base station 1002B to assign the highest power level to transmissions to mobile device 1006B, for base station 1002C to assign the middle power level to transmission to mobile device 1006C, and for transmitter 1002A to assign the lowest power level to transmissions to mobile device 1006A on those resources. In this way, interference from transmitters 1002A and 1002C to mobile device 1006B is reduced without compromising the quality of transmissions to mobile devices 1006A and 1006C. Across all three coverage areas 1004, this approach statistically reduces radio frequency interference levels without prohibiting any particular transmitters from using any of the available channels as long as the power backoff constraints are satisfied.

By defining a global pseudorandom number generating sequence and utilizing existing system measurement and messaging procedures, such as procedures designed for initial connectivity and mobility support, it is possible for each base station to both locally randomize power transmission levels for each sub channel over time, and to simultaneously have knowledge of the power levels of neighbors for current and future transmissions. This allows each base station to estimate signal to interference ratios that each user will experience during upcoming transmissions, and to allocate the best available resources to both satisfy the individual user's link and to minimize excessive interference into neighboring coverage areas. Therefore, embodiments of process 500 reduce net interference, increase net data throughput and increase overall coverage reliability across a plurality of coverage areas.

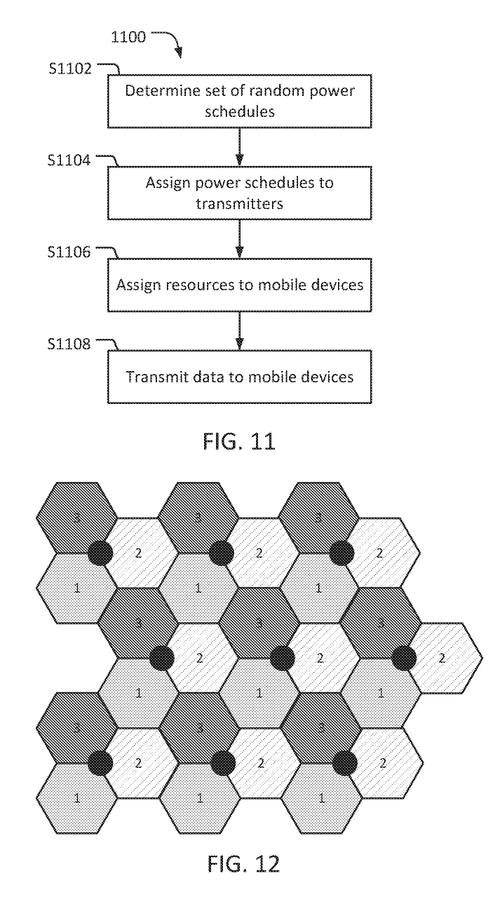

FIG. 11 illustrates a predetermined random power schedule process 1100. While many elements of process 1100 are similar to elements of process 500, the primary difference between these processes is that while random power schedules are determined on an ongoing basis in process 500, the random power schedules are predetermined in process 1100. Predetermined random power schedules may be generated by a central controller that distributes a set of predetermined random power schedules to a plurality of base stations. In other embodiments, a wireless communications system may use a set of predetermined random power schedules that are either pre-loaded at base stations, or pre-loaded at a central controller that then distributes the power schedules to transmitters.

A plurality of random power schedules are determined at S1102. The random power schedules may be determined PN generators as described above with respect to FIG. 9. Alternatively, the random power schedules may be generated using true random number generators.

The random power schedules may be statistically decorrelated to itself and to one another. In other words, a set of schedules may be determined at S1102 such that the cross-correlation of each binary sequence 910 from which a power schedule is derived is minimal. In addition, the binary sequences and/or the power schedules may be statistically decorrelated between one another so that no two schedules share more than a predetermined number of values for the same resources.

FIG. 4B shows a random power schedule with a plurality of grouped resources. The schedules determined at S1102 may have one or more schedules in which resources are grouped into various patterns. Each of these schedules may be selectively deployed according to the circumstances at a given base station.

The pool of predetermined random power schedules may be statistically decorrelated with one another. In an embodiment, the random power schedules may be statistically analyzed to ensure that the correlation between any two schedules is less than a threshold value.

Predetermined random power schedules are assigned to transmitters at S1104. In an embodiment; the random power schedules are assigned such that no two immediate neighbors share the same power schedule. These neighbor relationships may be defined by geographic proximity, coverage area overlap, or in cellular systems, tier relationships or mobility neighbor relations.

In an embodiment, a limited number of predetermined power schedules are allocated to transmitters in a network according to a reuse scheme.

FIG. 12 shows an embodiment of a reuse scheme for a wireless network. In FIG. 12, each black dot represents a base station with three transmit antennas, and the three hexagons connected to each black dot represent cells of the base station. There are three different shadings that correspond to numbers 1, 2 and 3, and each of those numberings corresponds to a particular random power schedule. Accordingly, FIG. 12 shows a reuse scheme of three at the cell level in a cellular telecommunications network.

However, FIG. 12 is merely an example of reuse. A reuse scheme used by embodiments may have a much larger level, such as 100 or 1000. In an embodiment in which a reuse scheme is already present in a wireless network, such as reuse of Physical Cell Identifiers (PCIs) in a cellular network, random power schedules may be assigned at S1104 according to the pre-existing reuse scheme.

In some embodiments, a reuse distribution pattern may be optimized by software to ensure an even distribution in a network. In other embodiments, predetermined random schedules are randomly distributed throughout a network.

Scheduled resources are assigned to mobile devices at S1106. The assignment of an appropriate time and frequency channel to each served user may be performed based on the serving base station's knowledge of power attributes of the transmissions from nearby base stations, as well as information received from each served user.

In other words, in an embodiment, each base station may assign channels to served users after making a predictive signal quality estimation of available resources such that the best or most appropriate resources may be allocated to each served user. This estimation may include information of both the neighbor base station power schedules, as well as neighbor cell signal strength and channel quality estimates provided by each served user.

Additionally each mobile device may report the relative signal strength of each neighboring transmitter using existing measurement and reporting mechanisms. In this way each base station can obtain information in terms of relative channel quality and an estimate of the isolation between each unique mobile device and the neighboring coverage area relative to signal strength and quality from the local serving base station.

In an embodiment, the packet data scheduler in each base station makes a channel quality estimate for each mobile device based on the reported relative signal strengths and frequency domain channel quality (e.g. CQI) reports combined with the base station's local knowledge of neighboring base stations per-channel transmit power schedules. This information is used to allocate appropriate channels to each user to both satisfy user network access and data throughput demands as well as to limit unnecessary interference to users in neighboring cells.

As discussed above, predetermined random power schedules may be changed at each transmitter at regular intervals. Each base station may cycle through a finite set of predetermined power schedules, so that the random power schedules are reused in a cyclic manner.

In another embodiment, each base station may use the same set of random power schedules. In such an embodiment, the use of particular schedules may be indexed to a reuse scheme to ensure that neighboring transmitters do not transmit using the same power schedules at the same time.

After the resources have been allocated, data is transmitted to mobile devices at 1108.

This disclosure provides a method and system for provisioning channel schedules to wireless network base stations such that transmit power is varied in such a way as to reduce the probability of interference from an adjacent coverage area. Embodiments of this disclosure can be implemented to provide a simple and statically provisioned method of assigning transmit power levels to individual time and frequency resources in a pseudorandom manner across neighboring wireless base stations such that the probability of interference from neighboring transmitters is reduced, leading to higher levels of coverage reliability and higher network throughput.

Numerous variations of the specific examples of this disclosure are possible. For example, it is possible to schedule other transmission properties, such as phase, in a similar fashion to power.

Although this disclosure uses terminology that is specific to certain wireless technologies, persons of skill in the art will recognize that concepts can be applied to other technologies that use different terminology. For example, in some instances, this disclosure uses the term “transmitter” to refer to transmission-specific elements of a base station generically. In some of these instances, LTE terminology refers to such elements as a cell. Similarly, the term “cell” is used with respect to specific cellular embodiments, the principles of which can be applied to other technologies that do not use the term “cell” in the same fashion. Therefore, the embodiments of this disclosure should be interpreted as exemplary rather than limiting.

Embodiments of this disclosure provide numerous advantages to wireless communications technologies. Embodiments may be controlled centrally or locally. In addition, embodiments result in substantial reductions of the effects of interference without placing restrictions on access to portions of the channel pool (e.g. fractional frequency reuse) or the cost and complexity of a closed loop adaptation processes.

What is claimed is:

1. A method for a wireless communications network, the method comprising:
determining a first random power schedule for a first base station, wherein the first random power schedule is an orthogonal frequency division multiplexing (OFDM) schedule that associates a random distribution of a plurality of power levels with a corresponding plurality of time and frequency resources;
assigning the plurality of time and frequency resources to a plurality of mobile devices; and
transmitting data from the first base station to the plurality of mobile devices at the respective plurality of power levels.

2. The method of claim 1, wherein determining the first random power schedule includes generating a sequence of values using a pseudorandom number generator located at the first base station.

3. The method of claim 2, wherein the pseudorandom number generator is seeded with a seed value associated with the first base station, and
wherein the seed value is known to a plurality of neighboring base stations that neighbor the first base station.

4. The method of claim 2, wherein, a binary sequence output from the pseudorandom number generator is converted into a set of integers, each integer of the set of integers corresponding to each power level of the plurality of power levels, and a resulting sequence of power levels is applied to the random power schedule.

5. The method of claim 2, wherein the first base station determines random power schedules of neighboring base stations by inputting respective seed values for the neighboring base stations into the pseudorandom number generator and advancing the output sequences according to a frame count.

6. The method of claim 1, wherein determining the first random power schedule includes selecting the first random power schedule from a predetermined set of power schedules.

7. The method of claim 6, further comprising:
determining a plurality of random power schedules for a plurality of base stations in the wireless communications network from the predetermined set of power schedules based on a reuse scheme.

8. The method of claim 1, further comprising:
comparing the first random power schedule to random power schedules of neighboring base stations,
wherein the transmissions are assigned to the plurality of mobile devices based on a result of the comparison.

9. The method of claim 1, wherein the first random power schedule is replaced with a second random power schedule at a predetermined time interval.

10. The method of claim 9, wherein the first base station determines respective random power schedules of neighboring base stations using a number of the predetermined time intervals that have elapsed since an origin time.

11. A wireless communication system comprising:
a first base station;
one or more processor; and
one or more non-transitory computer readable medium with computer-executable instructions stored thereon which, when executed by the one or more processor, perform the following operations:
determining a first random power schedule for the first base station, wherein the first random power schedule is an orthogonal frequency division multiplexing (OFDM) schedule that associates a random distribution of a plurality of power levels with a corresponding plurality of time and frequency resources;
assigning the plurality of time and frequency resources to a plurality of mobile devices; and
transmitting data from the first base station to the plurality of mobile devices at the respective plurality of power levels.

12. The method of claim 10, wherein determining the first random power schedule includes generating a sequence of values using a pseudorandom number generator located at the first base station.

13. The method of claim 12, wherein the pseudorandom number generator is seeded with a seed value associated with the first base station, and
wherein the seed value is known to a plurality of neighboring base stations that neighbor the first base station.

14. The method of claim 12, wherein, a binary sequence output from the pseudorandom number generator is converted into a set of integers, each integer of the set of integers corresponding to each power level of the plurality of power levels, and a resulting sequence of power levels is applied to the random power schedule.

15. The method of claim 12, wherein the first base station determines random power schedules of neighboring base stations by inputting respective seed values for the neighboring base stations into the pseudorandom number generator and advancing the output sequences according to a frame count.

16. The method of claim 10, wherein determining the first random power schedule includes selecting the first random power schedule from a predetermined set of power schedules.

17. The method of claim 16, further comprising:
determining a plurality of random power schedules for a plurality of base stations in the wireless communications network from the predetermined set of power schedules based on a reuse scheme.

18. The method of claim 10, further comprising:
comparing the first random power schedule to random power schedules of neighboring base stations,
wherein the transmissions are assigned to the plurality of mobile devices based on a result of the comparison.

19. The method of claim 10, wherein the first random power schedule is replaced with a second random power schedule at a predetermined time interval.

20. The method of claim 19, wherein the first base station determines respective random power schedules of neighboring base stations using a number of the predetermined time intervals that have elapsed since an origin time.
